(19) United States
(12) Patent Application Publication
(10) Pub. No.: US 2025/0243056 A1
(43) Pub. Date: Jul. 31, 2025

(54) OPTIMIZED NATURAL GAS/SALES GAS/SOUR GAS REFORMING EMPLOYING A NOVEL CATALYTIC PROCESS AT THE INDUSTRIAL SCALE

(71) Applicant: ARAMCO SERVICES COMPANY, Houston, TX (US)

(72) Inventors: Elizabeth Q. Contreras, Houston, TX (US); Xiao Jiang, Bedford, MA (US); Sampath K. Bommareddy, Sugarland, TX (US)

(73) Assignee: ARAMCO SERVICES COMPANY, Houston, TX (US)

(21) Appl. No.: 18/424,451

(22) Filed: Jan. 26, 2024

(51) Int. Cl. C01B 3/40; C01B 3/50

(52) U.S. Cl. CPC C01B 3/40; C01B 3/506; C01B 2203/0405; C01B 2203/0435; C01B 2203/0485; C01B 2203/1011; C01B 2203/1241; C01B 2203/1258; C01B 2203/168

(57) ABSTRACT

A system for hydrogen production including a first separation system, a first purification unit, a second purification unit, an oxygen scavenger, a catalytic reactor, a second separation system, and a liquefier. A method for hydrogen production including separating oxygen-containing components from a feed also containing hydrogen sulfide and methane. The method further includes separating the hydrogen sulfide from the methane and feeding the hydrogen sulfide to a first purification unit. The method includes feeding the methane to a second purification unit. The method further includes feeding the purified hydrogen sulfide and methane to an oxygen scavenger unit to remove residual oxygen before reacting the two streams in a catalytic reactor. The method includes separating the gaseous hydrogen and liquid carbon disulfide exiting the catalytic reactor and then purifying and liquefying the gaseous hydrogen stream to produce a purified liquid hydrogen stream.

### BACKGROUND

Because of the current global focus on reducing carbon dioxide emissions to slow down global warming, hydrogen has a strong potential to be used as a clean fuel that only produces water during combustion.

A common source of hydrogen is natural gas containing larger amounts of hydrogen sulfide, called sour gas. The natural gas must be sweetened to remove the acidic impurities before use in gas processing plants, using processes such as methane steam reforming, partial oxidation, and thermal pyrolysis. These processes still produce carbon dioxide while generating hydrogen. Accordingly, there exists a need for an efficient hydrogen production process without concurrent carbon dioxide production.

### SUMMARY

This summary is provided to introduce a selection of concepts that are further described below in the detailed description. This summary is not intended to identify key or essential features of the claimed subject matter, nor is it intended to be used as an aid in limiting the scope of the claimed subject matter.

In one aspect, embodiments disclosed herein relate to a system for hydrogen production including a first separation system to remove oxygen-containing components from a feed stream to produce a hydrogen sulfide containing stream and a methane containing stream. The system further includes a first purification unit to receive the hydrogen sulfide containing stream and produce a purified hydrogen sulfide stream. There is a second purification unit configured to receive the methane containing stream and produce a purified methane stream. An oxygen scavenger unit treats the purified hydrogen sulfide and methane streams. A catalytic reactor reacts the purified hydrogen sulfide and methane streams in the absence of oxygen to produce an effluent with hydrogen and carbon disulfide. There is a second separation system to separate the effluent into a gaseous hydrogen stream and a liquid carbon disulfide stream. There is a liquefier to transition the gaseous hydrogen stream to a liquid hydrogen stream.

In another aspect, embodiments disclosed herein relate to a method for hydrogen production including separating oxygen-containing components from a feed mixture consisting of oxygen containing components, hydrogen sulfide, and methane. The hydrogen sulfide is separated from the methane and is fed to a first purification unit to produce a purified hydrogen sulfide stream. The methane is fed to a second purification unit to produce a purified methane stream before removing a residual amount of oxygen from the hydrogen sulfide and methane streams using an oxygen scavenger unit. The hydrogen sulfide and methane streams are reacted in a catalytic reactor to produce an effluent consisting of a mixture of gaseous hydrogen and liquid carbon disulfide. This mixture is separated to form a gaseous hydrogen stream and a separate liquid carbon disulfide stream. The gaseous hydrogen stream is purified and liquefied.

Other aspects and advantages of the claimed subject matter will be apparent from the following description and the appended claims.

### BRIEF DESCRIPTION OF DRAWINGS

FIG. 1 is a process diagram in accordance with one or more embodiments.

FIG. 2 is a schematic of catalysts in accordance with one or more embodiments.

FIG. 3A-3B are graphs comparing equilibrium compositions for hydrogen disulfide reforming and decomposition in accordance with one or more embodiments.

FIG. 4A-4C are graphs comparing hydrogen disulfide reforming and decomposition in equilibrium in accordance with one or more embodiments.

FIG. 5A-5B are graphs comparing enthalpy and Gibbs free energy for hydrogen disulfide reforming and decomposition in accordance with one or more embodiments.

FIG. 6A-6B are graphs comparing equilibrium conversion data for different feed rates of methane and hydrogen sulfide in accordance with one or more embodiments.

FIG. 7A-7B are graphs comparing equilibrium compositions for different feed rates of methane and hydrogen sulfide in accordance with one or more embodiments.

FIG. 8 is a table showing uses of carbon disulfide in accordance with one or more embodiments.

### DETAILED DESCRIPTION

In one aspect, embodiments disclosed herein relate to a system for hydrogen production using hydrogen disulfide reforming. In another aspect, embodiments disclosed herein relate to a method for hydrogen production using hydrogen disulfide reforming.

More specifically, embodiments herein are directed toward industrial scale systems and processes for reforming of hydrogen sulfide containing streams to produce hydrogen.

Feeds that may be advantageously processed according to embodiments herein include streams that contain hydrogen sulfide and methane. In some embodiments, the feed stream may be a mixture of primarily hydrogen sulfide and methane. In some embodiments, the feed stream may be this mixture with additional components including water, carbon dioxide, oxygenates, or combinations thereof. The feed stream may contain between 1 and 90% hydrogen sulfide. The feed stream may contain between 1 and 20% carbon dioxide. The feed stream may contain between 1 and 20% water. The feed stream may contain between 1 and 20% oxygen or oxygenates. Hydrogen sulfide containing natural gas is known as sour gas. The feed stream may be provided by industrial processes, such as oil and gas wells that produce sour gas or produce sour gas as an undesired byproduct. Various industrial streams resulting from processing of crude oils, as well as natural gas streams as produced from a reservoir, may contain an amount of hydrogen sulfide and methane. Natural gas streams may be lean or rich in hydrogen sulfide, and in oil and gas operations, gas produced from conventional or unconventional fields can have varying sulfur content on an average of around 1-10% (v/v) H₂S; with ultra-high H₂S wells producing 25-90% (v/v) H₂S. At the wellhead, sour natural gas compositions may include 40-90% hydrogen sulfide, for example. Natural gas streams as produced from a well may also include various other components, such as water, oxygen, carbon dioxide, among other impurities.

The above-described feed streams are separated and purified to recover a hydrogen sulfide stream and a methane stream. While the separation steps required may vary according to the feed composition, initial feed separation and purification may include absorption columns, stripping columns, distillation columns, incineration processes, scrubbers, membrane separators, compressors, cooling systems, heating systems, centrifugation, chemical scavenging, filtration, dialysis, size-exclusion chromatography, sublimation, precipitation, volatilization, electrodeposition, extraction, and chromatography. The separations steps may separate water, carbon dioxide, and oxygen from methane and hydrogen sulfide. The resulting streams are two purified methane and hydrogen sulfide streams.

Initial separations of the natural gas to recover methane and hydrogen sulfide may provide respective streams that are 98+% pure. Impurities that remain may include levels of oxygen, water, and carbon dioxide ranging from 0 to 40 ppb of each, for example. In some embodiments, however, downstream units may contain catalysts that are sensitive to oxygen-containing molecules. In such embodiments, the methane stream, the hydrogen sulfide stream, or a mixture of these streams, may be contacted with an oxygen scavenger to remove the remaining trace amounts of the oxygen-containing compounds to prevent catalyst fouling. Oxygen scavengers useful in embodiments herein may include reductive inhibitors, such as hydrazine and sodium sulfite. The oxygen scavengers are able to reduce oxygen to less than 5 ppb in the stream feeding the reactor.

In some embodiments, initial separation may use a catalyst packed column for oxygen removal using hydrogen gas to initiate a reaction between oxygen and hydrogen on the surface of the catalyst, producing water and removing oxygen from the feed stream. The residual carbon dioxide in the feed stream forms carbonic acid. Deoxygenated calcium hydroxide and sodium bicarbonate in the feed stream separate carbon dioxide from the feed gas by producing calcite. Any precipitate formed is filtered to provide a means of obtaining a deoxygenated feed of dry gases.

Following feed purification and separation, the hydrogen sulfide and methane are fed to a catalytic reaction zone to reform the hydrogen sulfide with methane to produce hydrogen and carbon disulfide (2 H₂S+CH₄→4 H₂+CS₂).

The hydrogen sulfide reforming reaction thus requires two moles of hydrogen sulfide per mole of methane. The feed stream provided to the system, however, may have varying amounts of these components, which may depend upon the reservoir being produced. Sour natural gas compositions having up to 90 vol % hydrogen sulfide, however, should still contain enough methane, on a molar basis, to meet the stoichiometric requirements of the reforming reaction.

Methane and hydrogen sulfide may be fed to the reactor at a molar ratio ranging between 5:1 to 1:5. Any excess methane may be recovered separately and fed to downstream units for recovery of the methane via normal processing routes for natural gas.

Catalysts that may be used in the hydrogen sulfide reforming reaction may include a heterogeneous site-isolated catalyst and may be configured for wet continuous processing or in a dry column configuration. Heterogeneous site-isolated catalysts consist of multiple catalysts of various chemical compositions within a capsule. These compositions may vary based on a semi-permeable shell membrane (aliphatic vs. aromatic compositions), the catalyst or reactive reagent housed within, the empty core, the tethering polymers, or the chemistries of the capsule (chemical initiators, photophores, oxygen scavengers, buffers, nanoparticles, titania, gold, iron, or carbon). Both single or multiple varieties of reactive capsules may be used to facilitate this reaction for higher efficiency and yield. The catalyst may be an inorganic-organic hybrid structure comprised of a highly crosslinked organic shell and a site-isolated catalyst in its core. Catalysts may be site-isolated by housing the catalyst within a micro-environment, allowing easy separation, recycling, and reuse of catalysts. Using a shell vesicular membrane for the catalyst may improve catalyst lifespan. The immiscibility of carbon disulfide in water allows for separation following the water suspended catalytic reaction. In other embodiments, the transparency of a high-molecular weight semi-permeable membrane of the catalyst allows for an irradiation catalyzed reaction to initiate hydrogen production. Site-isolated catalysts may prevent budding and fusing, and catalyst aggregation and precipitation. Budding may cause single point growth, ineffectively reducing the catalyst concentration in the solution. Fusing may result in small volume particles combining into larger volume particles, ineffectively reducing surface area and decreasing catalyst efficiency. Site-isolated catalysts prevent catalytic reagents from forming an impermeable film where the polymer shell allows for diffusion to continue during the entire process because of the semi-permeable membrane. Catalyst aggregation may cause materials to aggregate irreversibly into larger volume particles. Precipitation caused by chemical instability such as catalyst fouling, or a decrease in solubility, may cause reactive incompatibility with contaminants. Any decrease in volume and surface area may cause a change in reaction efficiency. The catalyst may lower operating temperature and increase production yield.

The wet continuous processing configurations may use liquid solvents to suspend platform catalysts into solution. Examples of suitable liquid solvents include water, ethanol, diethyl ether, benzene, toluene, methanol, and acetone. The shell membrane is highly crosslinked and insoluble in both aqueous (acidic and alkaline) and organic solvents. This solution allows fluids to reach the heterogeneous catalyst while stirring or static, as fluids continuously permeate with reactive catalysts, and react to neutralize H₂S/CH₄ into H₂ and CS₂. which may then permeate out. Housed with a semi-permeable membrane, the reactive catalyst reacts with incoming gases, including methane and H₂S. The reactants pass through the semi-permeable capsules and enter into the core to improve the proximity between reactants and the catalyst within the core. This structure allows reaction products to then escape and permeate outwardly through the semi-permeable capsule over time.

The dry packed adsorption column configurations may use a single column or multiple columns packed with a solid free-flowing powder catalyst. For multi-column systems, the beds of granular powder may be arranged in series, parallel, or lead lag configurations. A lead lag configuration consists of at least two beds in series and a bypass around the first bed. In this configuration of a packed bed column design, the first bed is designed to lead the catalytic reaction and the second bed follows behind it for any unreacted materials or reagents. If the first bed appears to be approaching exhaustion, it may be bypassed for the secondary bed that has been in use but to a lesser extent, allowing the first bed to be replenished. In some embodiments, both a dry and a wet column may be used to separate liquid/gas mixtures. In some embodiments, glass reactors, or glass-lined reactors may be used. The use of packed beds and sieved trays separates the products produced in the catalytic reaction.

Following conversion, a reaction effluent recovered from the reactors may be separated to recover the desired products, hydrogen and carbon disulfide. The reactor effluent may include undesired byproducts and unreacted feed components, including unreacted hydrogen sulfide and unreacted methane, accounting for less than 4 ppm of H₂S as a byproduct in the reaction product stream. The use of efficient upstream feed purification to remove carbon dioxide may minimize the production of various oxygenates as undesired reaction byproducts.

The reaction effluent may be separated, for example, using gas-liquid separation apparatus to separate the liquid carbon disulfide from the gaseous components of the reaction effluent. Depending upon the reaction efficiency and the required hydrogen purity, the remaining gaseous components (hydrogen and any unreacted hydrogen sulfide and/or methane) in the effluent may be separated to recover a hydrogen product stream and one or more of a byproduct stream or a recycle stream. Unreacted hydrogen sulfide may be neutralized to less than 4 ppm, while unreacted methane may be recycled, used in subsequent reactions as energy, or collected for other uses. The small quantities of unreacted gases remaining will be sweetened for disposal. The final product will contain up to 10 wt % hydrogen and up to 91 wt % carbon disulfide. To separate the liquid carbon disulfide from the gaseous hydrogen, phase separation and density gas-gas and gas-liquid hierarchical separation is used, separating the products by taking advantage of the differences in density.

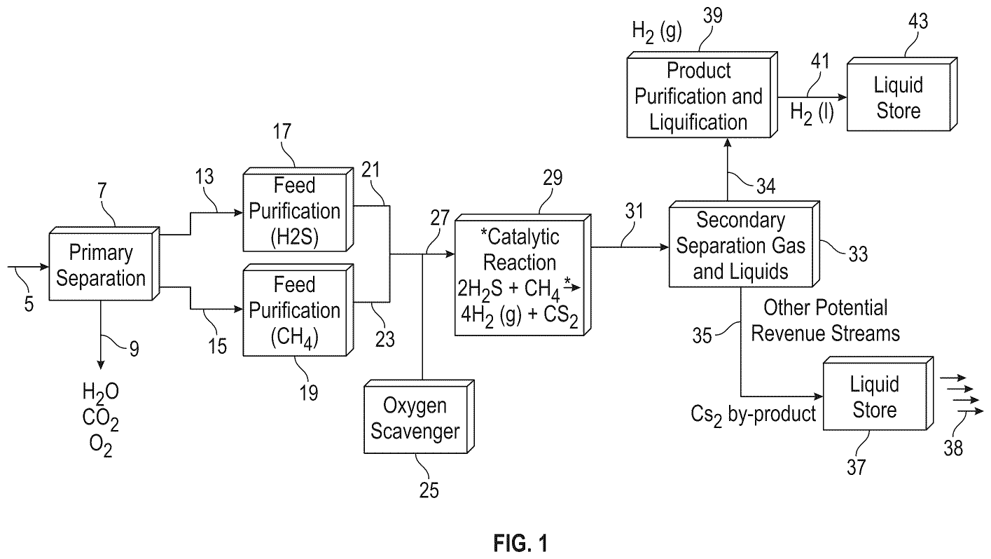

FIG. 1 shows a process diagram in accordance with one or more embodiments. The system contains a first separation system 10 that receives a feed stream 5. In some embodiments, the feed stream 5 contains hydrogen sulfide from a gas well. The feed stream 5 is at a temperature between 8° and 180° C. The first separation system 10 is configured to remove oxygen-containing components 9 from the feed stream 5, producing a hydrogen sulfide containing stream 13 and a methane containing stream 15. The hydrogen containing stream 13 is at a temperature between 2° and 600° C. The oxygen-containing components that are separated from the feed stream include water, carbon dioxide, and oxygen. Removing the oxygen-containing components prevents low-temperature methane oxidation and the formation of sulfates and carbonates that may decrease efficiency and increase catalyst fouling as these components may cause undesirable side reactions. The first separation system is used to create anoxic conditions with less than 1 ppm dissolved oxygen for the later reaction in the catalytic reactor to maintain high reaction efficiency with minimal byproduct formation. Dissolved oxygen in the feed stream may be removed by flowing the feed through a catalyst packed first separation system. In other embodiments, a membrane apparatus may serve as the first separation system. The feed stream may be maintained at ambient conditions.

The hydrogen sulfide containing stream 13 flows to a first purification unit 17 where additional membrane or catalytic packed apparatuses remove residual dissolved oxygen. The methane containing stream 15 flows to a second purification unit 19 that functions similarly to the first purification unit. The two purification units may be identical, may be combined into a single unit, or may be of different, separate configurations. The purification units may be glass-lined or Teflon-lined. Following purification, the purified hydrogen sulfide containing stream 21 exiting the first purification unit 17 combines with the purified methane containing stream 23 exiting the second purification unit 19. An oxygen scavenger unit 25 is situated along this combined stream 27 to remove any residual oxygen before the catalytic reactor that may result in undesirable side reactions. The oxygen scavenger unit may contain a packed apparatus containing sodium sulfite or hydrazine. An oxygen stripping packed apparatus is packed with solids that may scavenge for oxygen and reduce byproducts.

The combined stream containing hydrogen sulfide and methane 27 is fed to a catalytic reactor 29. The temperature within the catalytic reactor 29 ranges between 60° and 1200° C. In some embodiments, the combined stream containing hydrogen sulfide and methane 27 may flow through the catalyst to produce hydrogen. In other embodiments, the combined stream containing hydrogen sulfide and methane 27 may contact the catalyst in a dry column to neutralize hydrogen sulfide into hydrogen. In other embodiments, the combined stream containing hydrogen sulfide and methane 27 may contact the catalyst while it is suspended in water to neutralize hydrogen sulfide into hydrogen.

The catalytic reactor 29 reacts the hydrogen sulfide and methane stream 27 in the absence of oxygen, at a ratio ranging between 5:1 and 1:5 hydrogen sulfide to methane, producing an effluent 31 containing hydrogen and carbon disulfide. The reactor may be a gas-lined reactor to avoid corrosion from low pH products, including hydrogen and hydrogen sulfide.

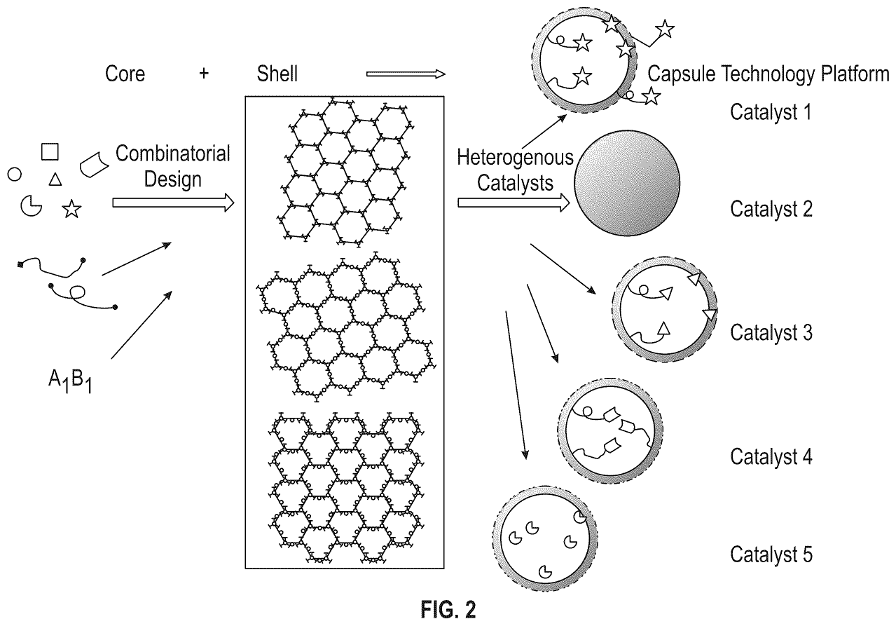

In some embodiments, the catalysts are encapsulated as shown in FIG. 2 in a capsule technology platform to provide site-isolated heterogenous catalysts using semi-permeable capsules (for example, vesicles, core/shell structures, beads, balloons, and 3D polymers). Different or similar catalysts may be included in a single capsule.

The dry column may contain a single bed or multiple beds. In some embodiments, the reactor 29 and the separator system 33 may be combined into a single process unit with packed beds containing a catalyst or packing on trays that may be used to concurrently react the feed gases, methane and hydrogen sulfide, to produce carbon disulfide and hydrogen. In this configuration, the bottoms of the single process unit may produce carbon disulfide, while the overhead product may contain hydrogen with unreacted hydrogen sulfide and methane to be processed in the product purification and liquefication unit, known as the liquefier 39. In the liquefier 39, unreacted hydrogen sulfide is converted through an amine absorption system, and the remaining methane and hydrogen may be separated to provide a pure hydrogen stream.

The effluent 31 containing hydrogen and carbon disulfide is fed to a second separation system 33 configured to separate the effluent into a gaseous hydrogen stream 34 and a liquid carbon disulfide stream 35. Carbon disulfide separates particularly easily from hydrogen due to the significant differences in density between gaseous hydrogen and liquid carbon disulfide, the difference in phase between the hydrogen and carbon disulfide, the pH differences between the hydrogen and carbon disulfide, and the reactivity properties with other reagents, allowing for a low energy separation process. The second separation system 33 may be a decanter or a stripping vessel, utilizing the higher density of carbon disulfide compared to hydrogen. The gaseous hydrogen stream 34 is fed to a liquefier 39 configured to transition the gaseous hydrogen stream 34 to a liquid hydrogen stream 41. The gaseous hydrogen stream 34 is at ambient temperature. The liquefier 39 uses high pressure to compress the hydrogen gas for storage. The liquid hydrogen 41 exiting the liquefier 39 is sent to a first liquid storage unit 43.

The liquid carbon disulfide stream 35 exiting the second separation system 33 flows to a second liquid storage unit 37. The carbon disulfide may be used for other revenue purposes. In some embodiments, there may be a flow line 38 exiting the second liquid storage unit 37 for use in other applications. In other embodiments, the carbon disulfide may be removed from the second liquid storage unit 37 via a tanker for reuse in other applications. The carbon disulfide may be consumed by other processes simultaneously with production, further driving the reaction to completion as the carbon disulfide is consumed.

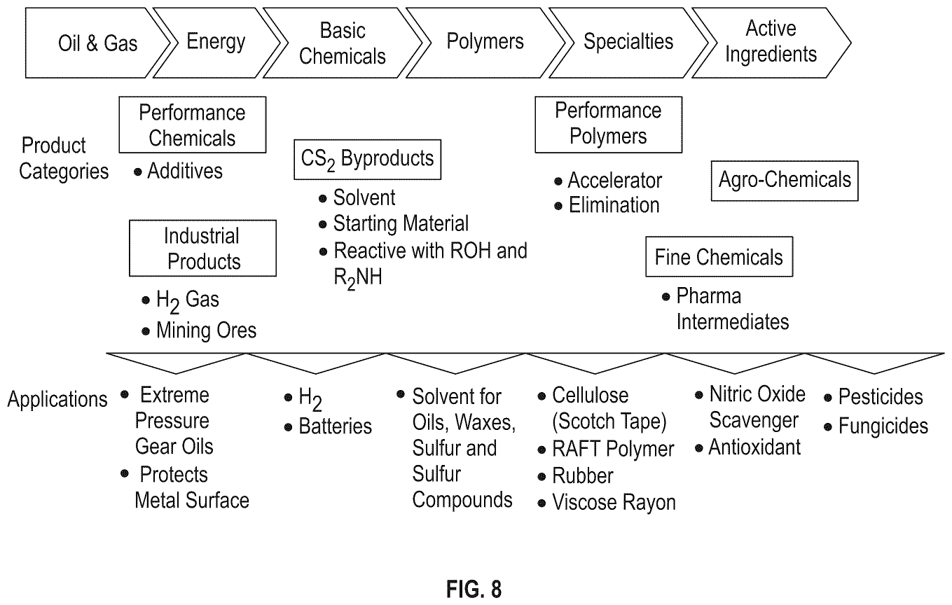

Applications for the carbon disulfide are listed in FIG. 8. In some embodiments, the carbon disulfide may be reacted with a primary or secondary amine or ammonia and sodium hydroxide to form dithiocarbamate salts. Dithiocarbamate salts may be used in rubber vulcanization, as an additive in pressure gear oils, as an antioxidant and metal surface protector, in pharmaceuticals as a nitric oxide scavenger, and in pesticides and fungicides. In other embodiments, the carbon disulfide may be reacted with a primary or secondary alcohol and potassium hydroxide to form xanthate salts that may be used commercially in uses including mining, polymers, rayon clothing, and rubber vulcanization accelerators. In other embodiments, carbon disulfide will be polymerized with carbon dioxide to utilize and reduce carbon dioxide.

### EXAMPLE

The system as described above with respect to FIG. 1 may be used to reform hydrogen sulfide at an industrial scale. For example, the feed stream may flow to the first separation system to remove contaminants and separate hydrogen sulfide and methane into individual streams. The stream of removed contaminants, including water, carbon dioxide, and water may exit the first separation system. The first separation system may produce between 675 and 915 tons per day of hydrogen sulfide and between 160 and 216 tons per day of methane in individual streams. These streams will be treated with an oxygen scavenger to remove any oxygen that may result in undesirable side reactions from the subsequent catalytic reaction. The oxygen scavenger 25 may remove oxygen from the stream feeding the catalytic reactor. The catalytic reaction may produce an effluent. The reaction effluent 31 may contain 2 to 12 mol % hydrogen, 80 to 95 mol % carbon disulfide, and 0.5 to 20 mol % of unwanted byproducts and unreacted materials. The reaction effluent 31 is fed to a second separation system to separate the hydrogen and carbon disulfide into separate streams. The second separation system produces between 80 and 108 tons per day of hydrogen and between 638 and 863 tons per day of carbon disulfide. The hydrogen is purified, liquefied, and stored. The carbon disulfide is also stored separately.

Calculations demonstrate the efficiency of the system and method, referred to as hydrogen sulfide reforming. For comparison, the calculations were also completed for hydrogen sulfide decomposition. Both processes produce hydrogen. As discussed previously, with hydrogen sulfide reforming, hydrogen sulfide and methane are reacted to produce hydrogen and carbon disulfide. With hydrogen sulfide decomposition, hydrogen sulfide decomposes to hydrogen and elemental sulfur. Based on the mass balance alone, hydrogen is produced with an efficiency of 9.5% during hydrogen sulfide reforming. In hydrogen sulfide decomposition, the efficiency of hydrogen production is 5.9%.

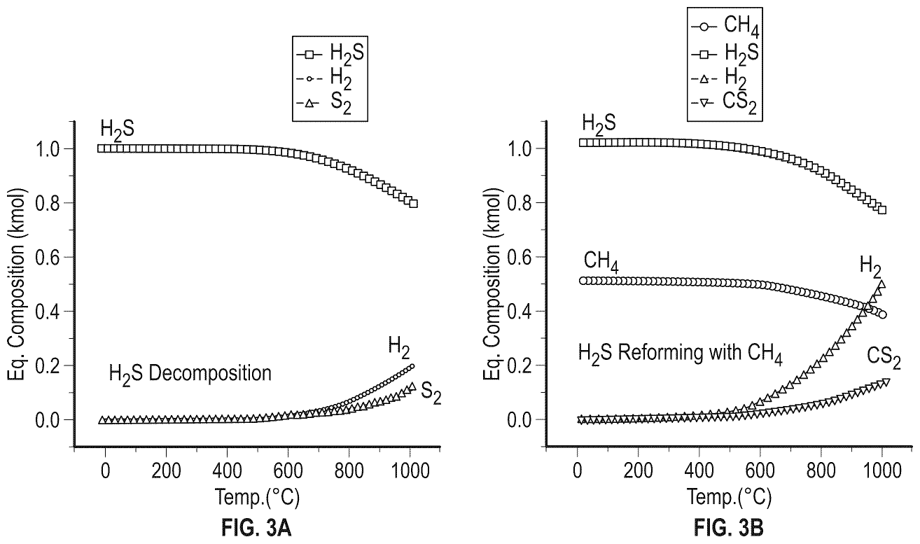

Referring to FIGS. 3A and 3B, thermodynamic calculations were completed based on the stoichiometries of hydrogen sulfide decomposition and reforming at ambient temperatures and pressures at equilibrium. Comparing FIG. 3A, where decomposition occurs, to FIG. 3B, where reforming occurs, clearly indicates that hydrogen has a higher equilibrium composition at high temperatures, and significantly more so during hydrogen sulfide reforming compared to decomposition. This confirms that hydrogen sulfide reforming has a higher hydrogen yield compared to hydrogen sulfide decomposition. The feed products decrease in equilibrium composition at higher temperatures. The conditions in FIGS. 3A and 3B minimized undesired byproducts, including oxygen scavengers and carbon dioxide, as well as dry reactions (without water as a product). Methane is used to decrease reaction temperature and displacing the products produced continued to drive the reaction forward.

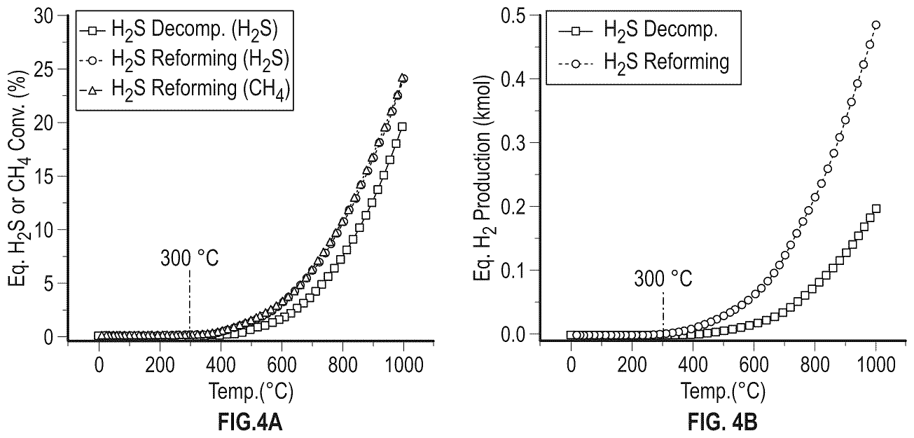

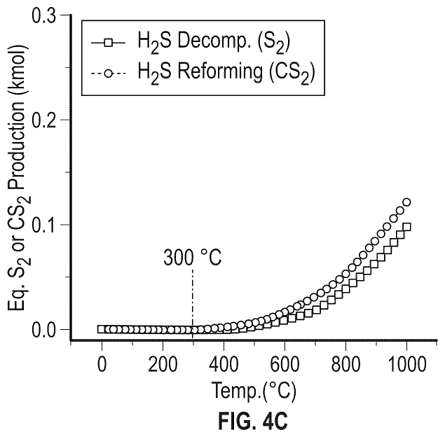

Referring to FIG. 4A, the equilibrium conversion for hydrogen sulfide decomposition is compared to that of hydrogen sulfide reforming for both hydrogen sulfide and methane at various temperatures FIG. 4A clearly demonstrates that hydrogen sulfide reforming presents a higher equilibrium conversion compared to hydrogen sulfide decomposition at temperatures above 300° C. FIG. 4B shows the equilibrium hydrogen production quantity (kmol) against temperature for hydrogen sulfide decomposition and reforming and indicates similar results, that above 300° C., the hydrogen production is significantly higher from the hydrogen sulfide reforming process. FIG. 4C shows a graph of the equilibrium quantities of the byproducts, sulfur and carbon disulfide against temperature for both hydrogen sulfide decomposition and reforming. FIG. 4C shows that while the production quantities of hydrogen are significantly more for hydrogen sulfide reforming compared to decomposition, the amount of byproduct production is only slightly more for the reforming process at temperatures above 300° C.

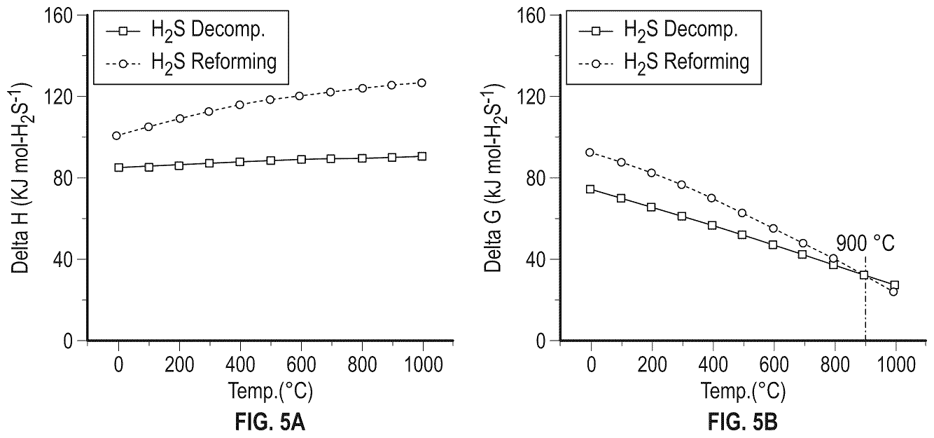

FIGS. 5A and 5B demonstrate the change in enthalpy and Gibbs free energy for the hydrogen sulfide decomposition and reforming processes against temperature. FIG. 5A indicates that hydrogen sulfide reforming is endothermic, requiring more energy. FIG. 5B shows that above 900° C., the Gibbs free energy is lower for the reforming process, indicating that reforming is more thermodynamically favorable at higher temperatures.

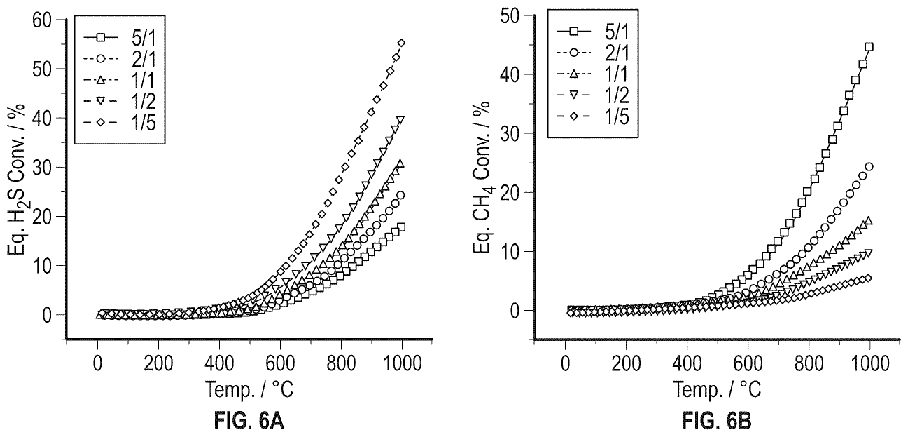

FIGS. 6A and 6B show the equilibrium conversion for hydrogen sulfide and methane against temperature at different feed ratios. The calculations assume ambient pressure and a starting amount of hydrogen sulfide of 1 kmol with a varying amount of methane at 0.2, 0.5, 1, 2, and 5 kmol. FIG. 6A indicates that a hydrogen sulfide to methane feed ratio of 1:5 yields the highest conversion for the production of hydrogen. FIG. 6B indicates the optimal methane to hydrogen sulfide ratio is 5:1 for the production of hydrogen. As shown in FIG. 6A, an excess hydrogen sulfide produces hydrogen even at a less optimal hydrogen sulfide to methane ratio of 5:1.

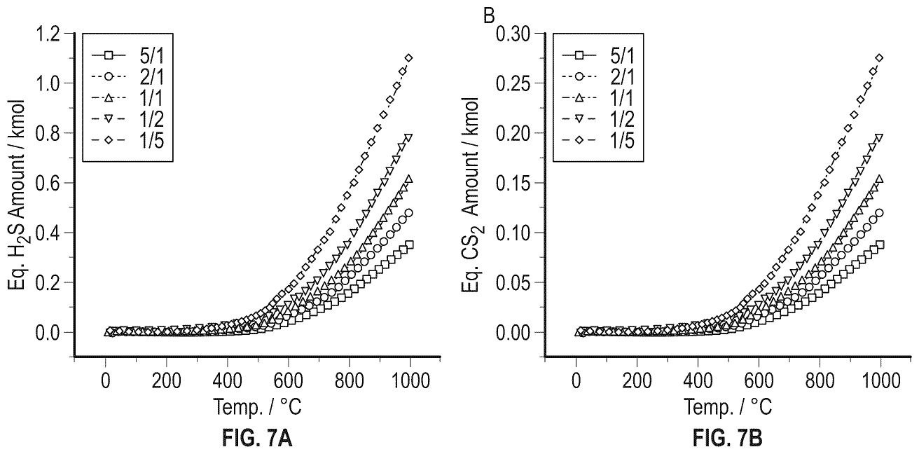

FIGS. 7A and 7B show the equilibrium quantities of hydrogen and carbon disulfide against temperature at different feed ratios. The calculations assume ambient pressure and a starting amount of hydrogen sulfide of 1 kmol with a varying amount of methane at 0.2, 0.5, 1, 2, and 5 kmol. FIG. 7A indicates that a hydrogen sulfide to methane feed ratio of 1:5 yields the highest production amount of hydrogen. FIG. 7B indicates that a hydrogen sulfide to methane feed ratio of 1:5 yields the highest production amount of carbon disulfide.

The data from the calculations indicate that the hydrogen sulfide reforming process has a higher conversion than that of hydrogen sulfide decomposition, with ideal operating temperatures between 800 and 1200° C. at ambient pressure. The ideal feed ratio of hydrogen sulfide to methane is 1:5. Hydrogen production is increased in comparison to the decomposition reaction at 400-600° C. As shown, higher temperatures drive the reaction forward. The use of a heterogeneous catalyst at this temperature range of up to 400-600° C. may increase the yield in hydrogen. At higher temperatures of 800-1200° C., hydrogen production is maximized with or without catalytic reactivity. This provides two forms of high efficiency in hydrogen production, using temperature, catalysis, and phase diagrams to increase reactivity.

Embodiments of the present disclosure may provide at least one of the following advantages. By generating hydrogen without carbon dioxide, this system and method allow for hydrogen production to be used as a carbon neutral energy source, reducing the carbon footprint of many industrial processes that can use hydrogen as fuel. Carbon disulfide is used as a raw material for industrial applications including high-performance additives, solvents, fine chemicals for the pharmaceutical industry, high-performance polymers, and agricultural chemical including pesticides and fungicides as shown in FIG. 8. FIG. 8 shows the many uses of carbon disulfide in industrial applications. The recycling capability of carbon disulfide is particularly notable in negating carbon dioxide emissions in industrial activities that would be produced if carbon disulfide needed to be generated specifically for a process. The specific catalysts used are site-isolated catalysts, which allow for enhanced surface area permeability, selectivity, and reactivity. Using a site-isolated catalyst within a polymer core also prevents catalyst loss and fouling.

Although only a few example embodiments have been described in detail above, those skilled in the art will readily appreciate that many modifications are possible in the example embodiments without materially departing from this invention. Accordingly, all such modifications are intended to be included within the scope of this disclosure as defined in the following claims

What is claimed:

1. A system for hydrogen production, comprising:
a first separation system configured to remove a plurality of oxygen-containing components from a natural gas feed stream, and produce a hydrogen sulfide containing stream and a methane containing stream;
a first purification unit configured to receive the hydrogen sulfide containing stream and produce a purified hydrogen sulfide stream;
a second purification unit configured to receive the methane containing stream and produce a purified methane stream;
an oxygen scavenger unit configured to treat the purified hydrogen sulfide stream and the purified methane stream;
a catalytic reactor configured to react the purified hydrogen sulfide stream and the purified methane stream in the absence of oxygen, producing an effluent containing hydrogen and carbon disulfide;
a second separation system configured to separate the effluent into a gaseous hydrogen stream and a liquid carbon disulfide stream; and
a liquefier configured to transition the gaseous hydrogen stream to a liquid hydrogen stream.

2. The system of claim 1, wherein the first separation system is selected from the group consisting of a catalyst, a membrane, or a combination thereof.

3. The system of claim 1, wherein the first purification unit and the second purification are combined into a single purification unit.

4. The system of claim 1, wherein the first purification unit and the second purification unit are separate units.

5. The system of claim 1, wherein the oxygen scavenger unit is a stripping packed apparatus.

6. The system of claim 1, wherein the catalytic reactor contains a heterogeneous site-isolated catalyst in an inorganic-organic hybrid structure.

7. The system of claim 1, wherein the heterogeneous site-isolated catalyst further comprises a crosslinked organic shell and site-isolated catalyst in the core.

8. The system of claim 1, wherein the reactor is a glass-lined reactor.

9. The system of claim 1, wherein the second separation system is a decanter.

10. A method for hydrogen production, comprising:
separating a plurality of oxygen-containing components from a feed mixture containing the plurality of oxygen containing components, hydrogen sulfide, and methane;
separating the hydrogen sulfide from the methane;
feeding the hydrogen sulfide to a first purification unit, producing a purified hydrogen sulfide stream;
feeding the methane to a second purification unit, producing a purified methane stream;
removing an amount of residual oxygen containing components from the hydrogen sulfide stream and the methane stream using an oxygen scavenger unit;
reacting the hydrogen sulfide stream and the methane stream in a catalytic reactor, producing an effluent containing a mixture of gaseous hydrogen and liquid carbon disulfide;
separating the mixture of gaseous hydrogen and liquid carbon disulfide to form a gaseous hydrogen stream and a liquid carbon disulfide stream; and
purifying and liquefying the gaseous hydrogen stream producing a purified liquid hydrogen stream.

11. The method of claim 10, wherein a molar ratio of the hydrogen sulfide stream to methane stream fed to the catalytic reactor is from 5:1 to 1:5.

12. The method of claim 10, wherein the hydrogen sulfide stream and the methane stream contain less than 1 ppm of oxygen.

13. The method of claim 10, wherein the reacting of the hydrogen sulfide stream and the methane stream occurs between 600 and 1200° C.

14. The method of claim 10, wherein the effluent containing a mixture of gaseous hydrogen and liquid carbon disulfide contains less than 4 ppm hydrogen sulfide.

15. The method of claim 10, wherein the purified liquid hydrogen stream comprises less than 4 ppm hydrogen sulfide.

16. The method of claim 10, further comprising feeding the liquid carbon disulfide stream to a process for the production of an additive, a pharmaceutical, a polymer, a pesticide, a fungicide, or a solvent.
